(19) United States
(12) Patent Application Publication
(10) Pub. No.: US 2010/0188854 A1
(43) Pub. Date: Jul. 29, 2010

(54) LIGHT EMITTING DEVICE

(76) Inventor: Andy-Ling King, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/358,245

(22) Filed: Jan. 23, 2009

(51) Int. Cl. F21V 7/22; G01J 3/10

(52) U.S. Cl. 362/296.04; 362/296.01; 250/504 R

(57) ABSTRACT

A light-emitting device for gently projecting light is disclosed. The light-emitting device includes a light emitter having a first electrode and a second electrode disposed on the light emitter for emitting light, an encapsulation for encapsulating the light emitter, part of the first electrode, and part of the second electrode with a concave lens disposed on one side of the encapsulation, a reflective material attached to the convex reflector, and a concave reflective substrate disposed beneath the encapsulation to manipulate light and meet specific illumination needs.

### BACKGROUND OF THE INVENTION

1. Field of the Invention

The present invention relates to a light-emitting device. In particular, the present invention relates to a light-emitting device with a set of concave mirrors (or reflectors) for gently and effectively projecting light.

2. Description of the Prior Art

The Illumination devices play an essential role in our daily life. With a proper illumination, life can be more comfortable and extra time becomes accessible after dark. The illumination devices are usually designed to be brighter to facilitate their usage. There are some practical practices to converge, diverge or reflect light by lenses or mirrors to provide desirable results for illumination.

For example, adding a convex lens focuses the light and enhances the brightness near its focus point. Conversely, light can be diverged from its source by a concave lens, and significantly reduces its brightness. Sometimes, mirrors are added to either re-direct the light or to achieve a better illumination result. For example, a concave reflector is commonly used in flashlights or headlights of automobiles to converge light and provide a higher and more uniform luminance (or lux, luminous flux per unit area). These examples illustrate prior arts in manipulating light for illumination devices.

Recent advances in the solid-state lighting, particularly for different kinds of light emitted diodes (LEDs), create sources of illumination other than the ordinary incandescent or fluorescent light. Although these devices emit light in the visible spectrum, they are not as sensitive as incandescent lights to the human eyes. To compensate for the visual sensation of brightness in human eyes, more intense light sources or converging devices are needed. For conventional LEDs, an integrated convex lens is built onto the encapsulation material in front of the light source to converge and project light. Additional improvement can be achieved by placing a flat reflective substrate in the back of LED array to reflect light emitted in the back direction. These devices have progressively appeared in the market place in the past few years. Despite of these advances, intense light emitted from the light source (not restricted to LED) can be irritating to the naked eyes and the collection of stray light emitted from its source can be improved. These challenges provide opportunities for innovation and will be addressed in this patent application.

In conclusion, there is a need to provide the public with a light-emitting device which can gently and evenly project light so the illumination is much more comfortable and acceptable to the human eyes.

### SUMMARY OF THE INVENTION

The present invention proposes an illumination device that can be more effective in collecting light from its source and produce a gentler illumination that is more pleasant to the human eyes.

The proposed illumination device includes a light source with its encapsulation and electrodes, and two reflectors. Two reflectors, one convex and one concave, are arranged in such a way that the light source is positioned between a small convex reflector in the front and a large concave reflector in the back. The front reflector blocks or partially blocks the forward illumination from its source and reflects it back to the large concave reflector in the back, therefore, reducing the irritation to the human eyes. The front reflector can be an integrated as part of the encapsulation material where a reflective metal is deposited directly on the convex surface of the encapsulation cylindrical, or an add-on device with a reflective material placed in front of the light source. Emitted and reflected light from all directions, including the aforementioned reflected light from the front reflector, will be projected forward by the large reflector in the back, therefore, enhancing its brightness. A softer illumination can be achieved by adding a surface texture to the back reflector. By adjusting the relative position of light source and its reflectors or changing the curvature of these reflectors, the luminance (or brightness) can be adjusted by the degree of light convergence and tailored specifically for its illumination needs. Spotlight, floodlight, as well as evenly illumination can, therefore, be achieved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 illustrate examples of the light-emitting device of the present invention.

### DETAILED DESCRIPTION

The present invention offers more effective means to project light from its source. The architecture of this invention permits an intense light to be illuminated evenly without irritating or harming to the human eyes.

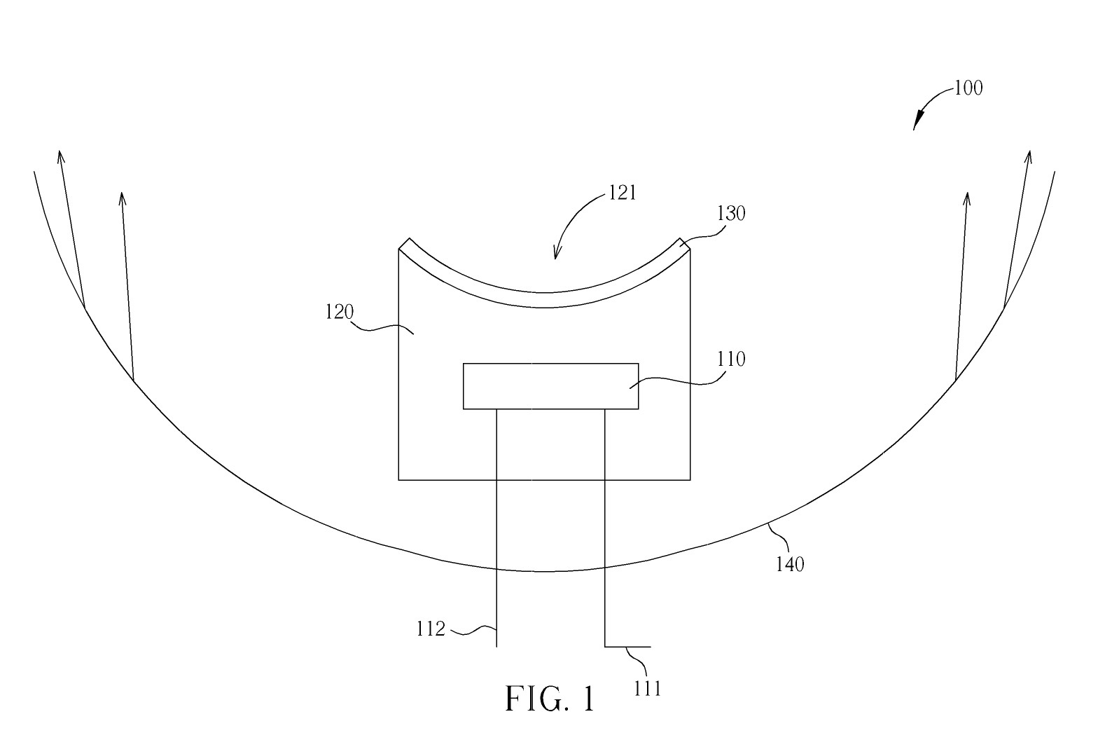

Please refer to FIG. 1, which illustrates an example of the light-emitting device of the present invention. The light-emitting device 100 of present invention includes a light emitter 110, an encapsulation 120, a reflective material 130 and a concave reflective substrate 140. The light-emitting device 100 can be any suitable illumination device. Some examples of the illumination device can be light bulbs, LEDs, OLEDs, PLEDS, halogen lamps or fluorescent lamps. Preferably, the light emitter 110 emits pre-determined light, such as infrared, visible light and/or UV light. The light-emitting device 100 may include fluorescent powder in its encapsulation.

The light emitter 110 usually has a first electrode 111 and a second electrode 112 connected to a power source. The encapsulation 120 is for encapsulating the light emitter 110, part of the first electrode 111 and part of the second electrode 112. If the light emitter 110 is an LED, the light emitter 110 may include a combination of a (III) group compound, such as GaAs, GaAlAs, GaN, GaP, InP or Sc and a (V) group compound, such as N, P or As, and the encapsulation 120 may include a resin, an epoxy material or both. Preferably, the encapsulation 120 is transparent or translucent to the emitted wavelength.

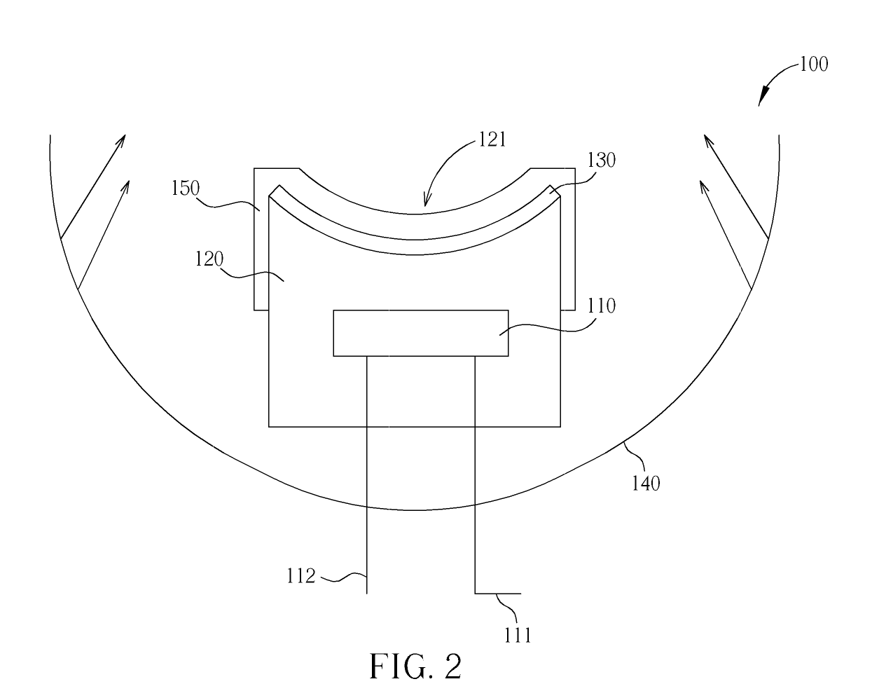

There is an optical element, a convex reflector 121 that is placed on one side of the encapsulation 120. This reflector can be either an integrated part of the encapsulation 120 or an add-on cap to the encapsulation, as illustrated in FIG. 1 and FIG. 2, respectively. The convex reflector 121 is positioned on the top of the encapsulation 120 so the light emitted by the light emitter 110 is not entirely and directly projected to the viewers. This is particularly important for in general lighting where intense lights can irritate or harm to the human's eyes.

Usually, the integrated convex reflector 121 is shaped as a part of encapsulation process when the encapsulation 120 is formed (see FIG. 1). A reflective material 130, such as Al, Ag, Cr, or Ni, can be deposited onto the concave surface by sputtering, evaporation deposition or any other suitable method such as electrodeposition.

The reflective material 130 may be fully reflective, semi-reflective or have tiny holes for the light to pass through.

The light emitter 110 may or may not have an add-on cap for capping the encapsulation 120. In one embodiment of the present invention, the light emitter 110 may be a light-emitting diode (LED) and has a cap 150 for capping the encapsulation 120 so that the reflective material 130 is “interiorly” disposed between the cap 150 and the encapsulation 120, as shown in FIG. 2.

There is a concave reflective reflector 140 located beneath the encapsulation 120 to reflect all the light emitted from it light source. The light emitter 110 is, therefore, located between the front reflective material 130 and the back concave reflective substrate 140 so that the light emitted by the light emitter 110 will be reflected between the reflective material 130 and the concave reflective substrate 140. The concave reflective substrate 140 may include at least a suitable metal, such as Al, Ag, Cr or Ni. Moreover, the convex lens 120 and the concave reflective substrate 140 together with the reflective material 130 may reflect the light to the viewers without focusing it. In such a way, the light to the viewers is presented in a gentle, more uniform and less bright form. In other words, the light from the light-emitting device 100 of present invention is much more acceptable and comfortable to the naked eye. The light-emitting device of the present invention is designed to be user friendly and to give softer illumination.

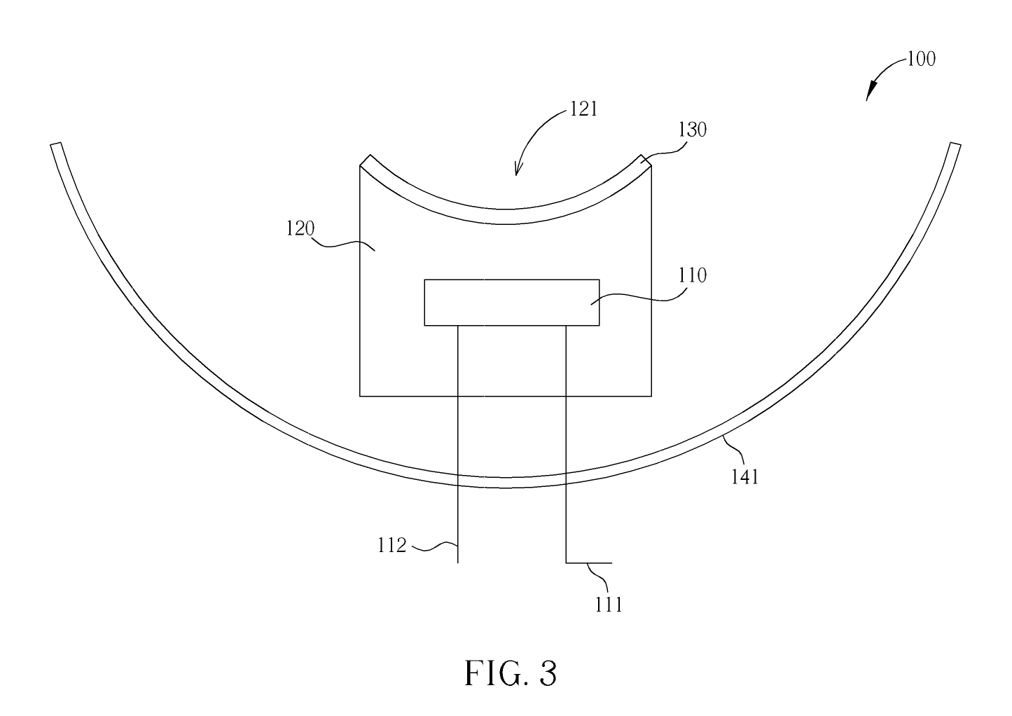

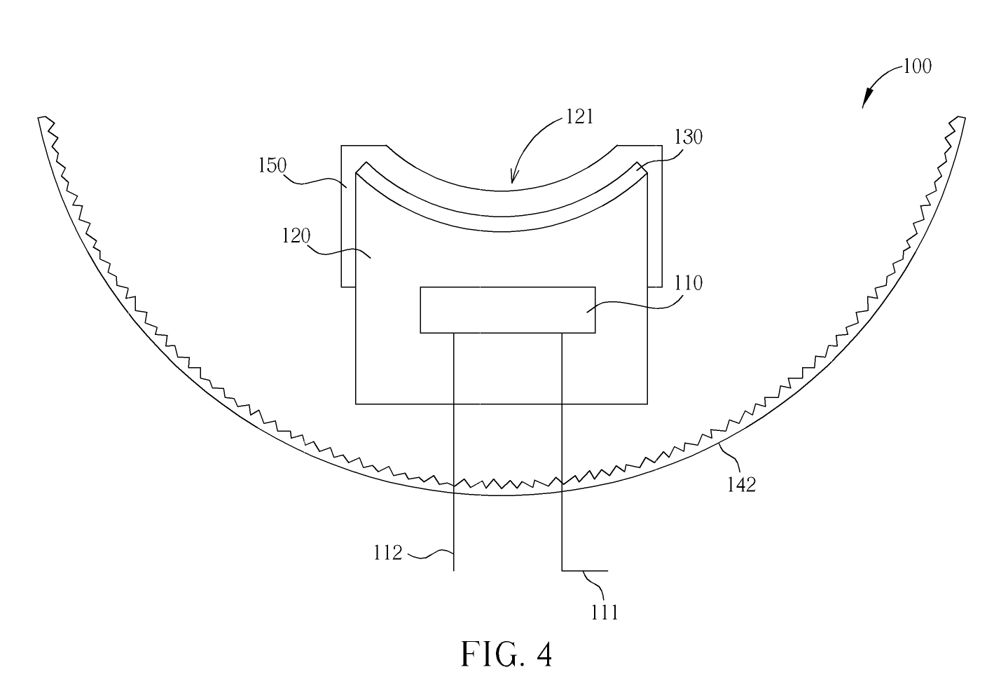

The light from the light emitter 110 can be manipulated through the change of position of the light emitter 110 or through the curvature of the reflective substrate 140 (back reflector) to create different illumination effect. For example, the light from the light emitter 110 may be spotlight (FIG. 2) or floodlight (FIG. 1), depending on different demands. Furthermore, a layer of coating 141 with different color, such as yellow, can be applied to the reflective substrate 140 to improve the visual sensation of the human eyes as shown in FIG. 3, or the texture 142 can be added to the reflective substrate 140 to create a softer illumination as shown in FIG. 4.

Those skilled in the art will readily observe that numerous modifications and alterations of the device and method may be made while retaining the teachings of the invention.

What is claimed is:

1. A light-emitting device, comprising:
a light emitter having a first electrode and a second electrode disposed on the light emitter for emitting light;
an encapsulation encapsulating said light emitter, part of said first electrode, and part of said second electrode with a convex reflector with a reflective material disposed on one side of said encapsulation; and
a concave reflective substrate disposed beneath said encapsulation.

2. The light emitting device of claim 1, wherein said light emitter emits light selected from a group consisting of infrared, visible light and UV light.

3. The light emitting device of claim 1, wherein said light emitter comprises a light emitting diode.

4. The light emitting device of claim 3, wherein said light emitting diode material comprises a (III) group compound.

5. The light emitting of claim 3, wherein said light emitting diode material comprises a (V) group material.

6. The light emitting device of claim 1, wherein said encapsulation comprises a resin.

7. The light emitting device of claim 1, wherein said encapsulation comprises an epoxy material.

8. The light emitting device of claim 1, wherein said convex reflector together with said reflective material reflects said light.

9. The light emitting device of claim 1, wherein said reflective material comprises a metal.

10. The light emitting device of claim 8, wherein said metal is selected form a group consisting of Ag, Al, Cr and Ni.

11. The light emitting device of claim 1, further comprising:
a cap for capping said encapsulation so that said reflective material is disposed between said cap and said encapsulation.

12. The light emitting device of claim 1, wherein said concave reflective substrate comprises a metal.

13. The light emitting device of claim 12, wherein said metal comprises Ag.

14. The light emitting device of claim 12, wherein said metal comprises Al.

15. The light emitting device of claim 1, wherein said concave lens is disposed on the top side of said encapsulation.

16. The light emitting device of claim 1, wherein said convex reflector and said concave reflective substrate together with said reflective material reflect said light without focusing said light.

17. The light emitting device of claim 1, wherein said light from said light emitter is spotlight.

18. The light emitting device of claim 1, wherein said light from said light emitter is floodlight.

19. The light emitting device of claim 1, wherein a texture is added to said concave reflective substrate to create a soft illumination.

20. The light emitting device of claim 1, wherein a coating is applied to said concave reflective substrate.
